(19) United States
(12) Patent Application Publication
(10) Pub. No.: US 2026/0213164 A1
(43) Pub. Date: Jul. 23, 2026

(54) SILICON CONTAINING COMPOSITE MATERIAL AND METHOD FOR PRODUCING SAME

(71) Applicant: TALGA TECHNOLOGIES LIMITED, Cambridgeshire (GB)

(72) Inventors: Fengming LIU, Reading Berkshire (GB); Binglin TAO, Great Cambourne, Cambridgeshire (GB); Anna Moisala MOTTA, Cambridge, Cambridgeshire (GB); Karanjeet RAYIAT, Middlesex (GB)

(21) Appl. No.: 19/141,753

(22) PCT Filed: Dec. 22, 2023
(86) PCT No.: PCT/IB2023/063156

§ 371 Date: Jun. 20, 2025

(30) Foreign Application Priority Data
Dec. 22, 2022 (AU) 2022903983

(51) Int. Cl. H01M 4/36; C04B 35/524; C04B 35/626; C04B 35/628; C04B 35/64; H01M 4/02; H01M 4/38; H01M 4/587

(52) U.S. Cl. CPC H01M 4/366; C04B 35/524; C04B 35/6261; C04B 35/62655; C04B 35/62695; C04B 35/62839; C04B 35/64; H01M 4/386; H01M 4/587; C04B 2235/425; C04B 2235/428; C04B 2235/48; C04B 2235/5445; C04B 2235/5454; C04B 2235/656; C04B 2235/77; C04B 2235/963; H01M 2004/027

(57) ABSTRACT

The present invention relates to a silicon containing composite material comprising a plurality of silicon nanoparticles located within a carbon matrix, and an amorphous carbon external shell provided encompassing the silicon nanoparticles and carbon matrix, wherein the thickness of the amorphous carbon external shell is between about 10 nm to 5000 nm.

### FIELD OF THE INVENTION

The present invention relates to a silicon containing composite material. More particularly, the composite material of the present invention is intended for use as an anode material in lithium-ion batteries.

In one highly preferred form, the present invention further relates to an anode composite comprising a silicon containing composite material.

The present invention still further relates to a method for producing a silicon containing composite material.

### BACKGROUND ART

Presently, silicon/graphite composites are understood to show some promise as a lithium-ion anode material. However, there are number of well-known and understood disadvantages relating to silicon/graphite composites. These disadvantages include high levels of expansion, up to 400%, and poor cycle life. Any commercial application of silicon/graphite composites would need to address at least these issues.

The irreversible capacity loss of presently known and understood silicon-containing anodes is currently addressed through the use of nano-structured silicon particles as the electroactive material. It has been reported that silicon nanoparticles and nanostructured silicon are more tolerant of volume changes on charging and discharging when compared to microscale particles (X H Liu et al., “Size-Dependent Fracture of Silicon Nanoparticles During Lithiation”, ACS Nano, 2012, 6 (2), 1522-1531). However, nanoscale particles are not considered to be suitable for commercial scale applications as they are known to be difficult to prepare and handle. In addition to issues relating to silicon particle size, the nature of the silicon surfaces also plays an important role in the formation of the Solid Electrolyte Interphase (SEI) and electronic conductivity. The SEI on the surface of the silicon is not stable and continuously consumes lithium, requiring the modification of the surface so as to avoid, or at least reduce, the exposure of silicon to the electrolyte. Further, silicon is not considered a particularly good conductive material.

A core-shell structured graphite/silicon@pyrolysed-carbon (Gr/Si@C) composite has been fabricated, including mechanical milling, spray drying, and the use of pitch (Li et al, “Scalable synthesis of a novel structured graphite/silicon/pyrolysed carbon composite as anode material for high-performance lithium-ion batteries”, Journal of Alloys and Compounds 688 (2016) 1072-1079). In this prior art process, what appears to be a relatively scalable and cost-effective method is demonstrated. Due to the carbon coating of the silicon and graphite present, the cyclability has been much improved relative to much prior art. However, the demonstrated low first cycle efficiency of 77.9% at a capacity of 637.7 mAh/g is far from the level required of the battery industry.

International Patent Application PCT/GB2018/051689 (WO 2018/229515) describes firstly the production of silicon nanoparticles through the ball milling of silicon microparticles in a solvent. A pyrolytic ‘amorphous’ carbon precursor containing at least one oxygen or nitrogen atom is added to silicon nanoparticles and a solvent, the solvent is removed, and the remaining silicon nanoparticles are coated with a thick layer of the pyrolytic carbon precursor. In turn these coated silicon nanoparticles are pyrolysed, forming composite particles comprising a plurality of silicon nanoparticles dispersed in a conductive pyrolytic carbon matrix. In this prior art process, due to the use of a large amount of amorphous carbon, significant First Cycle Loss (FCL) and expansion are still substantial problems. It is believed that the amorphous carbon contributes a large proportion of the unacceptable FCL and expansion experienced. In addition, once the Si@C expands, the connection between silicon and carbon weakens, as amorphous carbon is not elastic.

Using electroless plating of a thick layer of nickel on a micron sized silicon particle, a graphene-caged silicon structure was formed and outstanding cell performance, including high capacity, small expansion, long cycle life and low FCL, was achieved (Li et al., “Growth of conformal graphene cages on micrometre-sized silicon particles as stable battery anodes”, Nature Energy, Vol. 1., Article No. 15029 (2016)).

Few-layer graphene-coated silicon nanoparticles have also been described as being formed by way of Chemical Vapour Deposition (CVD) (Son et al., “Silicon carbide-free graphene growth on silicon for lithium-ion battery with high volumetric energy density”, Nature Communications, Vol. 6., Article No. 7393 (2015)). Again, these coated silicon nanoparticles are said to provide outstanding cell performance, including high capacity, small expansion, long cycle life and low FCL. However, the processes by which these graphene-coated materials are formed are known to be expensive and are not scalable, particularly not to the level required for commercial application.

A more cost-effective method of coating few-layer graphene on silicon is described in Patent Publication WO 2015/073674 A1, through the coating of silicon with graphene by way of bead-milling of a mixture of graphite and silicon. However, using this method does not yield a product with the required performance. For example, there is a substantial capacity drop (>45%) in the first 200 cycles.

US 2016/064731 (Jung Sung-Ho, et. al.) describes the manufacture of a carbon-silicon composite in which a silicon-carbon-polymer matrix is prepared and that is in turn heat-treated to carbonize the matrix. This carbonized matrix is pulverised and mixed with a carbon raw material, before then being carbonized to produce the carbon-silicon composite of the invention. This carbon-silicon composite is used as an anode slurry to provide an anode for a secondary battery.

US 2018/097229 (Jo Sungnim, et. al.) describes the manufacture of a negative active material comprising the formation of a silicon-carbon primary particle having an apparent density of about 2 grams per cubic centimetre or greater, thermally treating a plurality of the primary particles, a second carbonaceous material, and a foaming agent, to form a porous silicon-carbon secondary particle. This secondary particle may or may not be provided with a further coating layer.

The Applicant's International Patent Application PCT/IB2020/056050 (WO 2020/261194), the entire content of which is incorporated herein by reference, describes a silicon and graphite containing composite material comprising a plurality of silicon nanoparticles coated with graphite particles, few-layer graphene particles, graphite nanoparticles, a carbon matrix, and an amorphous carbon external shell, wherein each of the graphite particle coated silicon nanoparticles, the few-layer graphene particles, and the graphite nanoparticles are held within the carbon matrix. Also described is a method for the production of a composite material, the method comprising the method steps of:
(i) Subjecting silicon particles to a size reduction step with graphite particles in a solvent, optionally in the presence of a polymer, to produce graphite particle coated silicon nanoparticles, few-layer graphene particles and graphite nanoparticles;
(ii) Processing the product of step (i) with or without a binder to produce composites;
(iii) Thermal treatment of the composites of step (ii), thereby producing a composite material comprising a plurality of graphite particle coated silicon nanoparticles, few-layer graphene particles, graphite nanoparticles and a carbon matrix, wherein each of the particles are held within the carbon matrix;
(iv) Coating of the composite material of step (iii) with a binder; and
(v) Thermal treatment of the composite material of step (iv) thereby producing a shell comprising amorphous carbon.

After the thermal treatment of step (iii), the composite material's surface area (BET) is described as being in the range of about 70-120 m²/g, whereas after the thermal treatment of step (v), the material's BET is said to be in the range of about 10-30 m²/g, which is relatively high.

The Applicant's prior described composition and process also utilises a non-aqueous solvent, for example this solvent is provided in the form of isopropyl alcohol (IPA). It is understood however that IPA is costly and toxic, and the provision of a composition and process that does not require the use of IPA would be seen as advantageous.

As noted hereinabove, a particular problem for silicon containing anode materials is its expansion. The expansion will cause a composite particle's pulverization and the loss of the physical contact and active materials. In addition, the expansion also causes an unstable SEI layer, which may result in a continuous loss of lithium. Two approaches are usually used to overcome these problems. Firstly, using silicon nanoparticles, as the nanosized material has an improved tolerance to the described expansion and pulverization. Second, coating a layer of carbon on the silicon surface. With these treatments, the silicon anode performance can be significantly improved. However, the silicon-based anode is still not good enough for a practical use. It is believed that the SEI layer is still not stable enough because the conventional carbon layer on the silicon surface is not elastic and not uniform. So, the silicon anode with conformal graphene cages (Li et al., supra), or with a sliding graphene layer (Son et al., supra), provide relatively outstanding cell performance. However, the methods used to make these graphene coatings are expensive.

Therefore, the Applicants proposed the composite and process described in International Patent Application PCT/IB2020/056050 (WO 2020/261194), for reducing the net expansion from the silicon composite particle (secondary particle), whereby particles with engineered porosity were designed for buffering the expansion from the individual silicon particles in the secondary particle. However, it has in some cases been found that the porosity of the silicon composite particles could not be effectively used because the silicon expansion tends to occur in the outward direction rather than effectively utilising the internal empty spaces. The provision of a composition and process that provided a sufficiently thick and/or hard shell on the Si@C material that limited outward expansion during lithiation would hence be seen as advantageous.

The composite material and method of the present invention has as one object thereof to overcome substantially one or more of the above-mentioned problems associated with prior art processes, or to at least provide a useful alternative thereto.

The preceding discussion of the background art is intended to facilitate an understanding of the present invention only. This discussion is not an acknowledgement or admission that any of the material referred to is or was part of the common general knowledge as at the priority date of the application.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

Throughout the specification and claims, unless the context requires otherwise, references to “milled” or “milling” are to be understood to include reference to “ball milling” and “bead milling”, and references to “bead milling” or “ball milling” are to be understood to include reference to “milling”. Similarly, unless the context requires otherwise, references to “milling”, “ball milling” and/or “bead milling” are to be understood to include reference to “grinding”, and references to “grinding” are to be understood to include reference to “milling”, “bead milling” and/or “ball milling” as the context requires.

The term “relative” or “relatively” used in respect of a feature of the invention is intended to indicate comparison to that feature in the prior art and the typical characteristics of that feature in the prior art, unless the context clearly indicates or requires otherwise.

It is to be understood that the ranges provided herein include the stated range and any value or sub-range within the stated range. For example, a range from about 1 micrometer (μm) to about 2 μm, or about 1 μm to 2 μm, should be interpreted to include not only the explicitly recited limits of from between from about 1 μm to about 2 μm, but also to include individual values, such as about 1.2 μm, about 1.5 μm, about 1.8 μm, etc., and sub-ranges, such as from about 1.1 μm to about 1.9 μm, from about 1.25 μm to about 1.75 μm, etc. Furthermore, when “about” and/or “substantially” are/is utilised to describe a value, they are meant to encompass minor variations (up to +/−10%) from the stated value.

### DISCLOSURE OF THE INVENTION

In accordance with the present invention there is provided a silicon containing composite material comprising a plurality of silicon nanoparticles located within a carbon matrix, and an amorphous carbon external shell provided encompassing the silicon nanoparticles and carbon matrix, wherein the thickness of the amorphous carbon external shell is between about 10 nm to 5000 nm.

Preferably, the silicon nanoparticles are provided in the size range of between about 20 nm to 300 nm.

In one form of the invention a silicon material is milled to provide the silicon nanoparticles. Preferably, the silicon material is milled in a non-aqueous solvent so as to avoid the production of SiO₂ and other relatively dangerous by-products, for example SiH₄ and H₂.

In one form of the present invention, the carbon matrix has a density of below about 1.5 g/cc. In one form of the present invention, the carbon matrix has a porosity of above about 65%. In one form of the present invention, the carbon matrix has a surface area (BET) of between about 10 m²/g to 500 m²/g.

Preferably, the carbon matrix has one or more of:
(i) a density of below about 1.5 g/cc;
(ii) a porosity of above about 65%; and/or
(iii) a surface area (BET) of between about 10 m²/g to 500 m²/g.

The carbon matrix is preferably provided in the form of an amorphous carbon matrix, a crystalline carbon matrix, or a combination of both an amorphous carbon matrix and a crystalline carbon matrix.

Preferably, the carbon matrix comprises, in addition to the silicon nanoparticles, one or more of graphite, graphene, graphite nanoplates, carbon nanotubes, and carbon fibres.

The silicon nanoparticles are preferably encapsulated by the one or more of graphite, graphene, graphite nanoplates, carbon nanotubes, and carbon fibres.

The amorphous carbon shell has, in a preferred form, a density of greater than about 1.5 g/cc. Preferably, the surface area (BET) of the silicon containing composite material is less than about 10 m²/g, for example less than about 5 m²/g.

In one form, the amorphous carbon shell further comprises additional materials from the group of titanium, aluminium, zirconium, niobium and selenium, or their oxides.

Preferably, the composite material possesses a level of elastic properties conferred by the presence of one or more of the graphite particles, graphene, few-layer graphene and graphite nanoparticles that may be provided within the amorphous carbon matrix.

In accordance with the present invention there is further provided an anode composite comprising a composite material as described hereinabove.

In accordance with the present invention there is still further provided a method for the production of a composite material, the method comprising the method steps of:
(i) Passing silicon nanoparticles, a binder and one or more carbon sources to a first agglomeration step in which is formed a first composite in which the silicon nanoparticles are encapsulated with one or more of graphite, graphene, carbon nanotubes and carbon fibres, and the coated silicon nanoparticles are held in a carbon matrix;
(ii) Processing the first composite of step (i) and a binder in a coating step to produce composites with organic containing shells; and
(iii) Thermal treatment of the composites and shells of step (ii) whereby the organic material in the shells is converted to carbon thereby producing a composite material comprising a plurality of encapsulated silicon nanoparticles in a carbon matrix and about which is provided an amorphous carbon shell, wherein the thickness of the amorphous carbon external shell is between about 10 nm to 5000 nm.

In one form of the present invention an additional thermal treatment step is provided by which the binder employed in the first agglomeration step is converted to carbon and forms in part the carbon matrix of the first composite.

Preferably, the silicon nanoparticles are provided in the size range of between about 20 nm to 300 nm.

In one form of the invention a silicon material is milled in an initial step to provide the silicon nanoparticles of step (i). Preferably, the silicon material is milled in a non-aqueous solvent so as to avoid the production of SiO₂ and other relatively dangerous by-products, for example SiH₄ and H₂.

Still preferably, the size-reduction steps of the initial step is a grinding step. Still further preferably, the grinding step is conducted in one or more bead mills.

In one form of the present invention, the carbon matrix has a density of below about 1.5 g/cc. In one form of the present invention, the carbon matrix has a porosity of above about 65%. In one form of the present invention, the carbon matrix has a surface area (BET) of between about 10 m²/g to 500 m²/g.

Preferably, the carbon matrix has one or more of:
(i) a density of below about 1.5 g/cc;
(ii) a porosity of above about 65%; and/or
(iii) a surface area (BET) of between about 10 m²/g to 500 m²/g.

The carbon matrix is preferably provided in the form of an amorphous carbon matrix, a crystalline carbon matrix, or a combination of both an amorphous carbon matrix and a crystalline carbon matrix.

Still preferably, the carbon matrix comprises, in addition to the silicon nanoparticles, one or more of graphite, graphene, graphite nanoplates, carbon nanotubes, and carbon fibres.

In one form of the present invention, the amorphous carbon shell has a density of greater than about 1.5 g/cc. In one form of the present invention, the amorphous carbon shell has a surface area (BET) of less than about 45 m²/g, for example less than 10 m²/g.

Preferably, the amorphous carbon shell has:
(i) A density of greater than about 1.5 g/cc; and/or
(ii) A surface area (BET) of less than about 45 m²/g, for example less than 10 m²/g.

In one form, the amorphous carbon shell further comprises additional materials from the group of titanium, aluminium, zirconium, niobium and selenium, or their oxides.

In a further form of the present invention a further thermal treatment step is applied to the composite material of step (iii), whereby the surface area thereof is reduced to less than 5 m²/g.

Preferably, prior to the further thermal treatment step the composite material of step (iii) has a hydrocarbon applied thereto. This hydrocarbon may be provided in the form of dihydroxynapthalene, for example at 1 to 5 wt %.

In one form of the present invention an aqueous solvent is utilised in at least the thermal treatment of step (iii) and the further thermal treatment.

Preferably, the thermal treatment of step (iii) and the further thermal treatment each comprise the dissolution of dihydroxynapthalene in water.

Still preferably, the dihydroxynapthalene is dissolved in water at greater than about 70° C.

Preferably, the thermal treatment of step (iii), the additional thermal treatment and further thermal treatment are each provided in the form of pyrolysis.

Still preferably, the thermal treatments convert any binder present to amorphous carbon.

Preferably, the graphite particles of the milling step (i) are provided in the form of pre-exfoliated graphite particles.

In one form of the present invention, the milling process of step (i) produces graphene that attaches to the silicon nanoparticles.

The thermal treatment of step (iii) is preferably conducted at a temperature in the range of about 700° C. to 1100° C., for example in the range of about 850° C. to 1000° C.

The additional thermal treatment by which the binder employed in the first agglomeration step is converted to carbon and forms in part the carbon matrix of the first composite is conducted at a temperature in the range of about 500° C. to 700° C.

Preferably, the further thermal treatment step is conducted at a temperature in the range of about 800° C. to 1000° C., for example between about 850° C. and 950° C.

Preferably, the agglomeration steps comprise spray-drying.

In accordance with the present invention there is yet still further provided a method for the production of an anode composite, the method comprising the method steps of:
(i) Passing silicon nanoparticles, a binder and one or more carbon sources to a first agglomeration step in which is formed a first composite in which the silicon nanoparticles are encapsulated with one or more of graphite, graphene, carbon nanotubes and carbon fibres, and the coated silicon nanoparticles are held in a carbon matrix;
(ii) Processing the first composite of step (i) and a binder in a coating step to produce composites with organic containing shells; and
(iii) Thermal treatment of the composites and shells of step (ii) whereby the organic material in the shells is converted to carbon thereby producing an anode composite comprising a plurality of encapsulated silicon nanoparticles in a carbon matrix and about which is provided an amorphous carbon shell, wherein the thickness of the amorphous carbon external shell is between about 10 nm to 5000 nm.

In one form of the present invention an additional thermal treatment step is provided by which the binder employed in the first agglomeration step is converted to carbon and forms in part the carbon matrix of the first composite.

Preferably, the silicon nanoparticles are provided in the size range of between about 20 nm to 300 nm.

In one form of the invention a silicon material is milled in an initial step to provide the silicon nanoparticles of step (i). Preferably, the silicon material is milled in a non-aqueous solvent so as to avoid the production of SiO₂ and other relatively dangerous by-products, for example SiH₄ and H₂.

Still preferably, the milling of the initial step is a grinding step. Still further preferably, the grinding step is conducted in one or more bead mills.

In one form of the present invention, the carbon matrix has a density of below about 1.5 g/cc. In one form of the present invention, the carbon matrix has a porosity of above about 65%. In one form of the present invention, the carbon matrix has a surface area (BET) of between about 10 m²/g to 500 m²/g.

Preferably, the carbon matrix has one or more of:
(i) a density of below about 1.5 g/cc;
(ii) a porosity of above about 65%; and/or
(iii) a surface area (BET) of between about 10 m²/g to 500 m²/g.

The carbon matrix is preferably provided in the form of an amorphous carbon matrix, a crystalline carbon matrix, or a combination of both an amorphous carbon matrix and a crystalline carbon matrix.

Still preferably, the carbon matrix comprises, in addition to the silicon nanoparticles, one or more of graphite, graphene, graphite nanoplates, carbon nanotubes, and carbon fibres.

In one form of the present invention, the amorphous carbon shell has a density of greater than about 1.5 g/cc. In one form of the present invention, the amorphous carbon shell has a surface area (BET) of less than about 45 m²/g, for example less than 10 m²/g.

Preferably, the amorphous carbon shell has:
(i) A density of greater than about 1.5 g/cc; and/or
(ii) A surface area (BET) of less than about 45 m²/g, for example less than 10 m²/g.

In one form, the amorphous carbon shell further comprises additional materials from the group of titanium, aluminium, zirconium, niobium and selenium, or their oxides.

In a further form of the present invention a further thermal treatment step is applied to the anode composite of step (iii), whereby the surface area thereof is reduced to less than 5 m²/g.

Preferably, prior to the further thermal treatment step the anode composite of step (iii) has a hydrocarbon applied thereto. This hydrocarbon may be provided in the form of dihydroxynapthalene, for example at 1 to 5 wt %.

In one form of the present invention an aqueous solvent is utilised in at least the thermal treatment of step (iii) and the further thermal treatment.

Preferably, the thermal treatment of step (iii) and the further thermal treatment each comprise the dissolution of dihydroxynapthalene in water.

Still preferably, the dihydroxynapthalene is dissolved in water at greater than about 70° C.

Preferably, the thermal treatment of step (iii), the additional thermal treatment and further thermal treatment are each provided in the form of pyrolysis.

Still preferably, the thermal treatments convert any binder present to amorphous carbon.

Preferably, the graphite particles of the milling step (i) are provided in the form of pre-exfoliated graphite particles.

In one form of the present invention, the milling process of step (i) produces graphene that attaches to the silicon nanoparticles.

The thermal treatment of step (iii) is preferably conducted at a temperature in the range of about 700° C. to 1100° C., for example in the range of about 850° C. to 1000° C.

The additional thermal treatment by which the binder employed in the first agglomeration step is converted to carbon and forms in part the carbon matrix of the first composite is conducted at a temperature in the range of about 500° C. to 700° C.

Preferably, the further thermal treatment step is conducted at a temperature in the range of about 800° C. to 1000° C., for example between about 850° C. and 950° C.

Preferably, the agglomeration steps comprise spray-drying.

### BRIEF DESCRIPTION OF THE DRAWINGS

The present invention will now be described, by way of example only, with reference to one embodiment thereof and the accompanying drawings, in which:—

FIG. 1 is a schematic representation of a method for producing a composite material in accordance with the present invention;

FIG. 2 is a graphical representation of full-cell data from the testing of graphite and silicon-contained materials, one of the silicon contained materials, “coating 2”, being in accordance with the composite of the present invention;

FIG. 3 is a graphical representation of both specific capacity and capacity retention relative to cycle numbers for full-cell tests in a coin cell with an electrode density of 1.3 g/cm³, again with one of the silicon contained materials, “coating 2” of “G2”, being in accordance with the composite of the present invention;

FIG. 4 is a graphical representation of both specific capacity and capacity retention relative to cycle numbers for a composite material in accordance with the present invention, in a single layer pouch cell with an electrode density of 1.3 g/cm³; and

FIG. 5 is again a graphical representation of both specific capacity and capacity retention relative to cycle numbers for a composite material in accordance with the present invention, in a single layer pouch cell with an electrode density of 1.5 g/cm³ demonstrating further improvements in performance.

### BEST MODE(S) FOR CARRYING OUT THE INVENTION

The present invention provides a silicon containing composite material comprising a plurality of silicon nanoparticles located within a carbon matrix, and an amorphous carbon external shell provided encompassing the silicon nanoparticles and carbon matrix, wherein the thickness of the amorphous carbon external shell is between about 10 nm to 5000 nm.

The silicon nanoparticles are preferably provided in the size range of between about 20 nm to 300 nm. In one form of the invention a silicon material is milled to provide the silicon nanoparticles, for example the silicon material is milled in a non-aqueous solvent so as to avoid the production of SiO₂ and other relatively dangerous by-products, for example SiH₄ and H₂.

The carbon matrix has, in a preferred form:
(i) a density of below about 1.5 g/cc;
(ii) a porosity of above about 65%; and/or
(iii) a surface area (BET) of between about 10 m²/g to 500 m²/g.

Unless stated otherwise, references herein to surface area and surface area measurements are references to specific surface area as calculated using Brunauer-Emmett-Teller analysis and may be referenced as “BET”. A common instrument known in the art for measuring surface area (BET) is a Surface Area Analyzer or BET Analyzer.

Throughout the specification and claims, unless the context requires otherwise, “density”, will be understood to refer to the mass of many particles of a substance divided by the volume they occupy. Density should be understood to include the spaces (pores) between particles. Methods for determining density are well known in the art. A common instrument known in the art for measuring density is a density meter.

Throughout the specification and claims, unless the context requires otherwise, “porosity”, will be understood to refer to the fraction of the volume of voids over the total volume. Methods for determining porosity are well known in the art. One example technique to determine porosity is porosimetry. A common instrument known in the art for measuring porosity is a mercury porosimeter.

In one form the carbon matrix comprises, in addition to the silicon nanoparticles, one or more of graphite, graphene, graphite nanoplates, carbon nanotubes, and carbon fibres. The carbon matrix is provided in the form of an amorphous carbon matrix, a crystalline carbon matrix, or a combination of both an amorphous carbon matrix and a crystalline carbon matrix. The silicon nanoparticles are encapsulated by the one or more of graphite, graphene, graphite nanoplates, carbon nanotubes, and carbon fibres.

The amorphous carbon shell has, in a preferred form, a density of greater than about 1.5 g/cc. The surface area (BET) of the silicon containing composite material is less than about 10 m²/g, for example less than about 5 m²/g.

In one form, the amorphous carbon shell further comprises additional materials from the group of titanium, aluminium, zirconium, niobium and selenium, or their oxides.

The composite material ideally possesses a level of elastic properties conferred by the presence of one or more of the graphite particles, graphene, few-layer graphene and graphite nanoparticles that may be provided within the amorphous carbon matrix.

The present invention further provides an anode composite comprising a composite material as described hereinabove.

The present invention still further provides a method for the production of a composite material, the method comprising the method steps of:
(i) Passing silicon nanoparticles, a binder and one or more carbon sources to a first agglomeration step, for example a spray drying step, in which is formed a first composite in which the silicon nanoparticles are encapsulated with one or more of graphite, graphene, carbon nanotubes and carbon fibres, and the coated silicon nanoparticles are held in a carbon matrix;
(ii) Processing the first composite of step (i) and a binder in a coating step, for example a spray drying step, to produce composites with organic containing shells; and
(iii) Thermal treatment of the composites and shells of step (ii) whereby the organic material in the shells is converted to carbon thereby producing a composite material comprising a plurality of encapsulated silicon nanoparticles in a carbon matrix and about which is provided an amorphous carbon shell, wherein the thickness of the amorphous carbon external shell is between about 10 nm to 5000 nm.

Throughout the specification and claims, the term “encapsulated” in this context will be understood to refer to at least some of the silicon nanoparticles of the present disclosure being coated, in part, by the one or more of graphite, graphene, carbon nanotubes, and carbon fibres. The encapsulation of the silicon particles may be achieved, for example by passing silicon nanoparticles, a binder and one or more carbon sources that comprise one or more of graphite, graphene, carbon nanotubes and carbon fibres to a first agglomeration step, such as a spray drying step, in which is formed a first composite in which the silicon nanoparticles are encapsulated by the one or more of graphite, graphene, carbon nanotubes and carbon fibres.

In one form of the present invention an additional thermal treatment step is provided by which the binder employed in the first agglomeration step is converted to carbon and forms in part the carbon matrix of the first composite.

The silicon nanoparticles are preferably provided in the size range of between about 20 nm to 300 nm.

In one form of the invention a silicon material is milled in an initial step to provide the silicon nanoparticles of step (i), for example in the silicon nanoparticles are milled in a non-aqueous solvent so as to avoid the production of SiO₂ and other relatively dangerous by-products, for example SiH₄ and H₂.

The milling of the initial step is, for example, a grinding step. The grinding step may be conducted in one or more bead mills.

The carbon matrix has, in a preferred form:
(i) a density of below about 1.5 g/cc;
(ii) a porosity of above about 65%; and/or
(iii) a surface area (BET) of between about 10 m²/g to 500 m²/g.

In one form the carbon matrix is provided in the form of an amorphous carbon matrix, a crystalline carbon matrix, or a combination of both an amorphous carbon matrix and a crystalline carbon matrix.

The carbon matrix may comprise, in addition to the silicon nanoparticles, one or more of graphite, graphene, graphite nanoplates, carbon nanotubes, and carbon fibres.

The amorphous carbon shell has, in one form:
(i) A density of greater than about 1.5 g/cc; and/or
(ii) A surface area (BET) of less than about 45 m²/g, for example less than 10 m²/g.

In one form, the amorphous carbon shell further comprises additional materials from the group of titanium, aluminium, zirconium, niobium and selenium, or their oxides.

In a further form of the present invention a further thermal treatment step is applied to the composite material of step (iii), whereby the surface area thereof is reduced to less than 5 m²/g.

Prior to the further thermal treatment step the composite material of step (iii) has a hydrocarbon applied thereto. This hydrocarbon may be provided in the form of dihydroxynapthalene (DHN), for example at 1 to 5 wt %.

In one form of the present invention an aqueous solvent is utilised in at least the thermal treatment of step (iii) and the further thermal treatment. The thermal treatment of step (iii) and the further thermal treatment each comprise the dissolution of dihydroxynapthalene in water, for example the dihydroxynapthalene is dissolved in water at greater than about 70° C.

The thermal treatment of step (iii), the additional thermal treatment and further thermal treatment may each be provided in the form of pyrolysis, and the thermal treatments convert any binder present to amorphous carbon.

The graphite particles of the milling step (i) are in one form provided as pre-exfoliated graphite particles.

In one form of the present invention, the milling process of step (i) produces graphene that attaches to the silicon nanoparticles.

The thermal treatment of step (iii) is conducted at a temperature in the range of about 700° C. to 1100° C., for example in the range of about 850° C. to 1000° C.

The additional thermal treatment by which the binder employed in the first agglomeration step is converted to carbon and forms in part the carbon matrix of the first composite is conducted at a temperature in the range of about 500° C. to 700° C.

The further thermal treatment step is conducted at a temperature in the range of about 800° C. to 1100° C., for example between about 850° C. and 950° C.

The present invention yet still further provides a method for the production of an anode composite, the method comprising the method steps of:
(i) Passing silicon nanoparticles, a binder and one or more carbon sources to a first agglomeration step, for example a spray drying step, in which is formed a first composite in which the silicon nanoparticles are encapsulated with one or more of graphite, graphene, carbon nanotubes and carbon fibres, and the coated silicon nanoparticles are held in a carbon matrix;
(ii) Processing the first composite of step (i) and a binder in a coating step, for example a spray drying step, to produce composites with organic containing shells; and
(iii) Thermal treatment of the composites and shells of step (ii) whereby the organic material in the shells is converted to carbon thereby producing an anode composite comprising a plurality of encapsulated silicon nanoparticles in a carbon matrix and about which is provided an amorphous carbon shell, wherein the thickness of the amorphous carbon external shell is between about 10 nm to 5000 nm.

In one form of the present invention an additional thermal treatment step is provided by which the binder employed in the first agglomeration step is converted to carbon and forms in part the carbon matrix of the first composite.

The silicon nanoparticles may be provided in the size range of between about 20 nm to 300 nm. In one form of the invention a silicon material is milled to provide the silicon nanoparticles of step (i), for example the silicon material is milled in a non-aqueous solvent so as to avoid the production of SiO₂ and other relatively dangerous by-products, for example SiH₄ and H₂.

In one form the milling of the initial step is a grinding step and is, for example, conducted in one or more bead mills.

The carbon matrix has, on one form:
(i) a density of below about 1.5 g/cc;
(ii) a porosity of above about 65%; and/or
(iii) a surface area (BET) of between about 10 m²/g to 500 m²/g.

The carbon matrix is provided in the form of an amorphous carbon matrix, a crystalline carbon matrix, or a combination of both an amorphous carbon matrix and a crystalline carbon matrix. The carbon matrix comprises, in addition to the silicon nanoparticles, one or more of graphite, graphene, graphite nanoplates, carbon nanotubes, and carbon fibres.

The amorphous carbon shell has, in one form:
(i) A density of greater than about 1.5 g/cc; and/or
(ii) A surface area (BET) of less than about 45 m²/g, for example less than 10 m²/g.

In one form, the amorphous carbon shell further comprises additional materials from the group of titanium, aluminium, zirconium, niobium and selenium, or their oxides.

In a further form of the present invention a further thermal treatment step is applied to the anode composite of step (iii), whereby the surface area thereof is reduced to less than 5 m²/g. Prior to the further thermal treatment step the anode composite of step (iii) has, in one form, a hydrocarbon applied thereto. This hydrocarbon may be provided in the form of dihydroxynapthalene, for example at 1 to 5 wt %.

In one form of the present invention an aqueous solvent is utilised in at least the thermal treatment of step (iii) and the further thermal treatment. The thermal treatment of step (iii) and the further thermal treatment each comprise the preferable dissolution of dihydroxynapthalene in water, for example the dihydroxynapthalene may be dissolved in water at greater than about 70° C.

The thermal treatment of step (iii), the additional thermal treatment and further thermal treatment are each provided, for example, in the form of pyrolysis. The thermal treatments preferably convert any binder present to amorphous carbon.

In a preferred form, the thermal treatment of step (iii) is conducted at a temperature in the range of about 700° C. to 1100° C., for example in the range of about 850° C. to 1000° C.

The additional thermal treatment by which the binder employed in the first agglomeration step is converted to carbon and forms in part the carbon matrix of the first composite is conducted at a temperature in the range of about 500° C. to 700° C.

The further thermal treatment step is conducted at a temperature in the range of about 800° C. to 1000° C., for example between about 850° C. and 950° C.

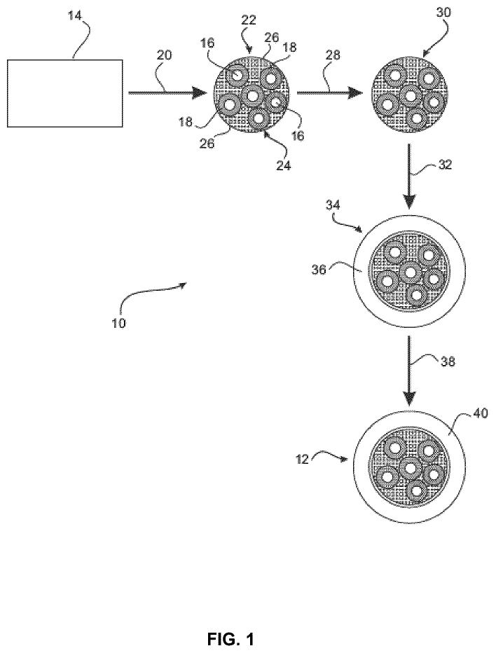

In FIG. 1 there is shown a process 10 in accordance with a first embodiment of the present invention, the process 10 being for the production of a composite material 12. In a first step a mixture 14 of silicon nanoparticles 16, binder, for example 1,5-dihydroxynapthalene (DHN), and one or more of graphite, graphene, carbon nanotubes and carbon fibres 18 are subjected to a first agglomeration step 20, for example spray drying, by which a first composite 22 is formed. In the first composite 22 the silicon nanoparticles 16 are encapsulated with the one or more of graphite, graphene, carbon nanotubes and carbon fibres 18, and resulting coated silicon nanoparticles 24 held in a carbon matrix 26. The binder employed in the agglomeration step 20 may also be provided in the form of a carbon source (not containing Cl, Br and/or S), for example pitch, glucose, sucrose and phenol formaldehyde resins.

The silicon nanoparticles 16 are provided in the size range of between about 20 nm and 300 nm.

The first composite 22 may then be subjected to a thermal treatment step 28 (elsewhere herein referred to as an additional thermal treatment step, as it is not described as present in all embodiments of the present invention), for example pyrolysis at a temperature in the range of about 500° C. to 700° C., by which the binder employed in the agglomeration step 20 is either fully or partially converted to carbon, providing a thermally treated first composite 30. Where the binder employed in the agglomeration step 20 is also a carbon source it is preferred that the first composite comprises low density carbon post-pyrolysis (for example, a density lower than that of the amorphous carbon shell described hereinafter as resulting from the thermal treatment step of the intermediate composite).

The first composite, whether it is a first composite 22 (not thermally treated) or a first composite 30 (thermally treated) may conveniently be referred to as a Si@C composite or material.

In what is elsewhere herein referred to as a second step, the first composite 22 or 30 is subjected to a coating step 32 with a binder, for example 1,5-dihydroxynapthalene (DHN), by which is produced an intermediate composite 34 having an organic shell 36 formed about the first composite 30. As the first composite 22 or 30 has a relatively large surface area (as noted hereinafter), the coating thereof with the organic shell 36 is readily achieved by way of simple mixing/spray drying agglomeration techniques.

In what is elsewhere herein referred to as a third step, the intermediate composite 34 is then subjected to a thermal treatment step 38, for example pyrolysis in a temperature range of about 700° C. to 1100° C., by which the 1,5-dihydroxynapthalene (DHN) binder employed in the coating step 32 is fully converted to amorphous carbon, thereby providing the composite material 12.

The composite material 12 comprises a plurality of encapsulated silicon nanoparticles 24 in the carbon matrix 26, about which is now provided a thermally treated, amorphous carbon shell 40.

The amorphous carbon shell 40 has a density of greater than about 1 g/cc, and/or a surface area of less than about 45 m²/g, for example less than 10 m²/g. Additives of one or more of titanium, aluminium, zirconium, niobium, selenium, tin, compounds containing one or more of these elements, and/or oxides of these elements, for example TiO₂, Al₂O₃, or SnO. It is envisaged that the composite material of the present invention may comprise a further thin film deposition about the shell 40. For example, an alumina layer of less than about 100 nm may be deposited thereon by way of atomic layer deposition.

The thick shell 40 is understood by the Applicants to reduce or prevent outward expansion of the composite material 12 during lithiation.

The binders employed in the first agglomeration step 20 and the coating step 32 may be the same, although the inventors have noted that it is preferable that the carbon from the binder employed in the coating step 32 is denser after heat treatment than the carbon obtained from the binder employed in the first agglomeration step 20 after heat treatment.

The composite material 12 may conveniently be referred to as a Si@C1@C2 composite or material.

In one form of the invention a silicon material is milled to provide the silicon nanoparticles 16. For example, the silicon material is milled in a non-aqueous solvent, such as IPA, so as to avoid the production of SiO₂ and other relatively dangerous by-products, for example SiH₄ and H₂. The milling may be undertaken as a grinding step and is, for example, conducted in one or more bead mills.

The carbon matrix 26 of the first composite material 28 or 30 has a density of below about 1.5 g/cc, a porosity of above about 65%, and a surface area (BET) of between about 10 m²/g to 500 m²/g, for example between about 40 m²/g and 50 m²/g. The high porosity is understood to be provided by the presence of the one or more of graphite, graphene, carbon nanotubes and carbon fibres 18. The high surface area is understood to be the result of the specific carbon sources utilised and/or the relatively low temperature pyrolysis employed.

Whilst not shown in FIG. 1, in one form of the present invention a further thermal treatment step, for example pyrolysis, at a temperature in the range of about 800° C. to 1000° C., for example about 850° C. to 950° C., is applied to the composite material 12, whereby the surface area thereof is reduced to less than 10 m²/g, for example equal to or less than 5 m²/g. Prior to the further thermal treatment step the composite material 12 has a hydrocarbon applied thereto, for example this hydrocarbon is provided in the form of 1,5-dihydroxynapthalene (DHN), for example at 1 to 5 wt %. This application of, for example, DHN and the further thermal treatment step provide a further composite or material that may be conveniently referred to as Si@C1@C2@C3.

An additional sieving step (also not shown) may also be applied to either or both the intermediate composite 34 or the composite material 12, to aid in material homogenisation and the reduction of surface area.

As described hereinabove, an aqueous solvent is utilised in at least the thermal treatment of step (iii) and the further thermal treatment. The thermal treatment of step (iii) and the further thermal treatment each comprise the preferable dissolution of dihydroxynapthalene in water, for example the dihydroxynapthalene may be dissolved in water at greater than about 70° C.

The process of the present invention may be better understood with reference to the following non-limiting examples.

### Example 1

### Talga Exfoliated Graphite

The Applicants have developed a unique exfoliated graphite (referred to by the Applicants as Talga HSA) for multiple applications, described in detail in International Patent Application PCT/GB2018/052095 (WO 019/020999), the entire content of which is incorporated herein by reference.

The Applicant's HSA has expanded gaps between the graphene layers in the graphite. So, compared to typical or ‘normal’ graphite, the graphene layers would be easier to peel off from the HSA and create Few Layer Graphene (FLG) during bead milling.

Full-Cell Data from Graphite and Silicon-Contained Materials

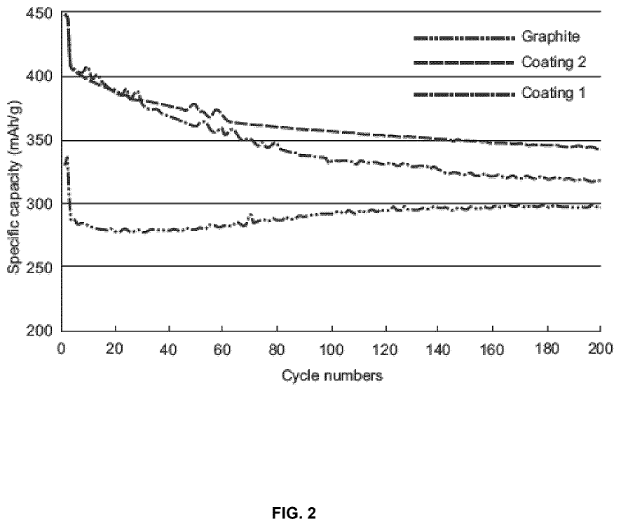

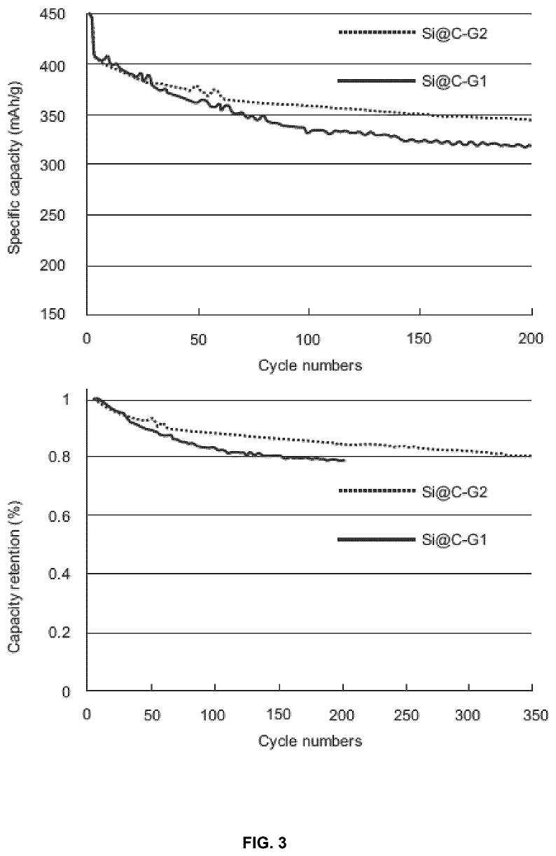

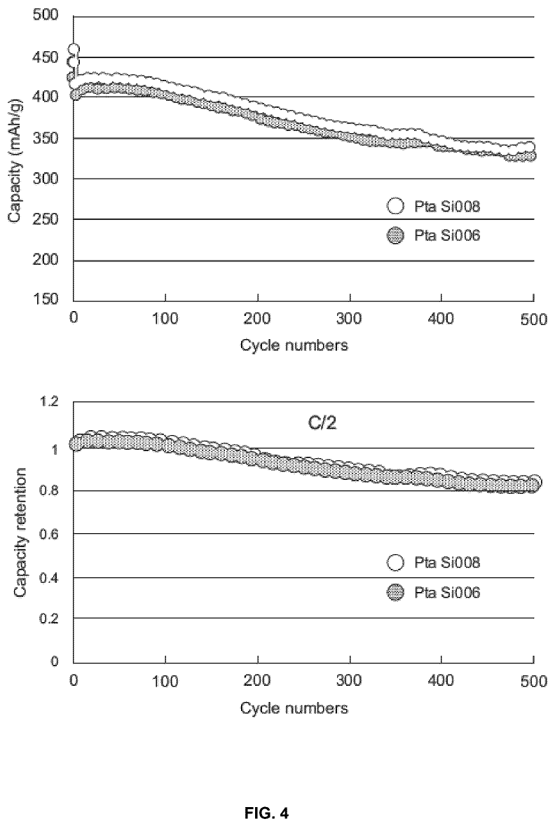

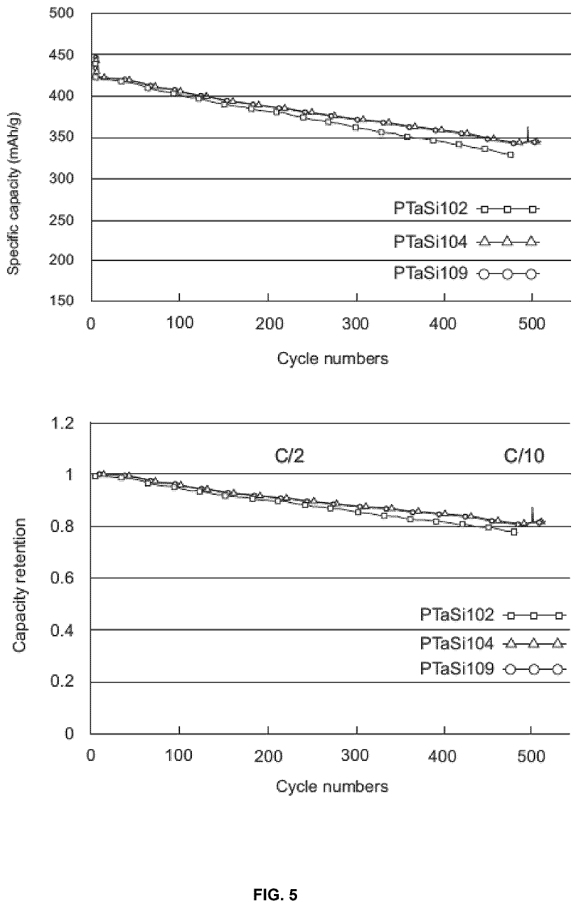

The results of full-cell testing are shown in FIGS. 2, 3, 4 and 5. All coatings are based on the same weight ratio of active material:CMC:SBR:Carbon additives=94:2:2:2. For “graphite”, the active material is natural graphite. For “coating 1” the active material is the mixture of 5% Si@C and 95% natural graphite. For “coating 2” the active material is the mixture of 5% Si@C1@C2 and 95% natural graphite. Both the silicon content in Si@C and Si@C1@C2 are about 60%. C=2C1=2C2 in weight and originates from the pyrolysis of 1,5-dihydroxynapthalene.

All full-cell tests were in the same protocol, being charge: 1^{st} & 2^{nd} cycle: C/10 to 4.2V then kept at 4.2 mV until C/100. Other cycles: C/2 to 4.2 then kept at 4.2V until C/10. Discharge: 1^{st} & 2^{nd} cycle: C/10 to 3.0V; other cycles: C2 to 3.0V. Cathode from NMC 111. N/P=1.05-1.10.

### Coin Cell Tests

With a further coating on the Si@C (Si@C-G2), the full cell cycle life at the 80% capacity retention increases from 150 cycles to 300 cycles. Si@C-G1: one coating. Si@C-G2: two coatings. The tests were carried out in a coin cell with the electrode density of 1.3 g/cm3. First cycle: charge at C/10 to 4.2V, the cut off current is C/100; discharge at C/10 until the voltage reaches 3.0V. Other cycles: charge at C/2 to 4.2V, the cut off current is C/10; discharge at C/2 until the voltage reaches 3.0V. Cathode: NMC111. N/P=1.03-1.1.

### Pouch Cell Tests

With a further coating on the Si@C, the full cell cycle life at the 80% capacity retention increases to 500 cycles in a single layer pouch cell with the electrode density of 1.3 g/cm3. First cycle: charge at C/10 to 4.2V, the cut off current is C/100; discharge at C/10 until the voltage reaches 3.0V. Other cycles: charge at C/2 to 4.2V, the cut off current is C/10; discharge at C/2 until the voltage reaches 3.0V. Cathode: NMC111. N/P=1.03-1.1.

With some further modifications (i.e., binders, calendering, composites) on the 2nd coated Si@C, the full cell cycle life at the 80% capacity retention achieved 500 cycles in a single layer pouch cell with the electrode density of 1.5 g/cm3. First cycle: charge at C/10 to 4.2V, the cut off current is C/100; discharge at C/10 until the voltage reaches 3.0V. Other cycles: charge at C/2 to 4.2V, the cut off current is C/10; discharge at C/2 until the voltage reaches 3.0V. Cathode: NMC111. N/P=1.03-1.1. This data meets the customer's basic requirement and the current market Si performance.

### Example 2

Testing conducted in accordance with the method of the present invention provides the following detail regarding pyrolysis temperature employed in the additional thermal treatment (described in this example as the “1^{st} pyrolysis” to designate it being the first pyrolysis step employed in the method undertaken in this example), and the thermal treatment (described in this example as the “2^{nd} pyrolysis” to designate it being the second pyrolysis step employed in the method undertaken in this example). The results for surface area (BET in m²/g) after the additional thermal treatment (1^{st} pyrolysis) and thermal treatment (2^{nd} pyrolysis) are set out in Table 1 below:

TABLE 1

| | | BET m²/g | | BET m²/g |
|---|---|---|---|---|
| Sample | 1^{st} pyrolysis | After 1^{st} | 2^{nd} pyrolysis | After 1^{st} |
| number | Temperature/° C. | pyrolysis | Temperature/° C. | pyrolysis |
| 1 | 600 | 108 | 750 | 58 |
| 2 | | | 850 | 17 |
| 3 | | | 950 | 10 |
| 4 | 700 | 115 | 750 | 37 |
| 5 | | | 850 | 18 |
| 6 | | | 950 | 23 |
| 7 | 800 | 98 | 750 | 44 |
| 8 | | | 850 | 22 |
| 9 | | | 950 | 29 |

Results for surface area after a further thermal treatment (described in this example as the “3rd pyrolysis” to designate it being the third pyrolysis step employed in the method undertaken in this example), using Sample 3 (the lowest surface area/BET sample from Table 1) as the starting material, are shown in Table 2 below:

TABLE 2

| | 1^{st} | | 2^{nd} | | 3rd | | 3rd |
|---|---|---|---|---|---|---|---|
| Sample | pyrol- | BET | pyrol- | BET | pyrol- | BET | Coating |
| number | ysis | m²/g | ysis | m²/g | ysis | m²/g | amount |
| 1 | 600 | 108 | 950 | 10 | 950 | 7.3 | 2 wt % |
| 2 | | | | | 950 | 7.74 | 5 wt % |
| 3 | | | | | 950 | 9.8 | 10 wt % |
| 4 | | | | | 950 | 4.0 | 33 wt % |

It was determined by the Applicants that if the surface area could be controlled between 40 m²/g to 50 m²/g then the surface area (BET) of the final product (Si@C1@C2@C3) after the further thermal treatment (3^{rd} pyrolysis) could be as low as 3 m²/g. Results for surface area/BET after the further thermal treatment (3^{rd} pyrolysis) when using a starting material having a surface area (BET) of 45 m²/g are shown in Table 3 below:

TABLE 3

| | 3^{rd} coating | | | | |
|---|---|---|---|---|---|
| | DHN amount | Weight before | Weight after | | |
| Sample | % | pyrolysis/g | pyrolysis/g | Yield | BET |
| 1 | 5 | 31.3 | 30.4 | 97.1 | 3.5 |
| 2 | 10 | 31.8 | 30.0 | 94.3 | 3.4 |
| 3 | 15 | 33.1 | 30.5 | 92.1 | 3.1 |

It is envisaged that the spray dryer described hereinabove may be advantageously replaced with at least either a spouted fluidised bed system or spray pyrolysis, for example, without departing from the scope of the invention.

As can be seen with reference to the above description, the composite material and method of producing same of the present invention provide one or more advantages when compared with the prior art, including the use of at least an outer shell of a thickness that is understood to reduce or prevent outward expansion during lithiation, this mechanical stability of the shell potentially being complemented in this through the incorporation of titanium, aluminium, zirconium, niobium, selenium and/or tin containing materials, whilst also providing an internal carbon matrix that has relatively high porosity and may thereby accommodate expansion occurring inside the composite material.

Modifications and variations such as would be apparent to the skilled addressee are considered to fall within the scope of the present invention.

1.-33. (canceled)

34. A silicon containing composite material comprising a plurality of silicon nanoparticles and one or more of graphite, graphene, graphite nanoplates, carbon nanotubes, and carbon fibres located within a carbon matrix, wherein the silicon nanoparticles are encapsulated with one or more of graphite, graphene, graphite nanoplates, carbon nanotubes, and carbon fibres, and an amorphous carbon external shell provided encompassing the silicon nanoparticles and carbon matrix, wherein the thickness of the amorphous carbon external shell is between about 10 nm to 5000 nm.

35. The composite material of claim 34, wherein the silicon nanoparticles are provided in a size range of between about 20 nm to 300 nm.

36. The composite material of claim 34, wherein:
(i) a silicon material is milled to provide the silicon nanoparticles; or
(ii) a silicon material is milled in a non-aqueous solvent to provide the silicon nanoparticles so as to avoid the production of SiO₂.

37. The composite material of claim 34, wherein the carbon matrix has:
(i) a density of below about 1.5 g/cc;
(ii) a porosity of above about 65%; and/or
(iii) a surface area (BET) of between about 10 m²/g to 500 m²/g.

38. The composite material of claim 34, wherein the carbon matrix is provided in the form of an amorphous carbon matrix, a crystalline carbon matrix, or a combination of both an amorphous carbon matrix and a crystalline carbon matrix.

39. The composite material of claim 34, wherein the composite material possesses a level of elastic properties conferred by the presence of one or more of the graphite, graphene, graphite nanoplates, carbon nanotubes, and carbon fibres provided within the amorphous carbon matrix.

40. The composite material of claim 34, wherein the amorphous carbon shell has a density of greater than about 1.5 g/cc.

41. The composite material of claim 34, wherein the surface area (BET) of the silicon containing composite material is less than about 10 m²/g.

42. The composite material of claim 34, wherein the amorphous carbon external shell further comprises additional materials from the group consisting of titanium, aluminum, zirconium, niobium and selenium, and their oxides.

43. An anode composite comprising:
a composite material comprising a plurality of silicon nanoparticles and one or more of graphite, graphene, graphite nanoplates, carbon nanotubes, and carbon fibres located within a carbon matrix, wherein the silicon nanoparticles are encapsulated with one or more of graphite, graphene, graphite nanoplates, carbon nanotubes, and carbon fibres, and an amorphous carbon external shell provided encompassing the silicon nanoparticles and carbon matrix, wherein the thickness of the amorphous carbon external shell is between about 10 nm to 5000 nm.

44. A method for the production of a composite material, the method comprising the method steps of:
(i) passing silicon nanoparticles, a binder, and one or more carbon sources, where the one or more carbon sources comprise one or more of graphite, graphene, graphite nanoplates, carbon nanotubes, and carbon fibres, to a first agglomeration step in which is formed a first composite comprising a plurality of silicon nanoparticles and one or more graphite, graphene, graphite nanoplates, carbon nanotubes, and carbon fibres located within a carbon matrix, where the silicon nanoparticles are encapsulated with one or more of graphite, graphene, carbon nanotubes and carbon fibres;
(ii) processing the first composite of step (i) and a binder in a coating step to produce composites with organic containing shells; and
(iii) thermal treatment of the composites and shells of step (ii) whereby the organic material in the shells is converted to carbon thereby producing a composite material comprising a plurality of silicon nanoparticles and one or more of graphite, graphene, graphite nanoplates, carbon nanotubes, and carbon fibres located within a carbon matrix, where the silicon nanoparticles are encapsulated with one or more of the graphite, graphene, carbon nanotubes and carbon fibres, and about which is provided an amorphous carbon shell, wherein the thickness of the amorphous carbon external shell is between about 10 nm to 5000 nm.

45. The method of claim 44, wherein an additional thermal treatment step is provided by which the binder employed in the first agglomeration step is converted to carbon and forms in part the carbon matrix of the first composite.

46. The method of claim 44, wherein the silicon nanoparticles are provided in a size range of between about 20 nm to 300 nm.

47. The method of claim 44, wherein a silicon material is milled in an initial step to provide the silicon nanoparticles of step (i).

48. The method of claim 47 wherein the silicon material is milled in a non-aqueous solvent so as to avoid the production of SiO₂, SiH₄, and H₂.

49. The method of claim 47, wherein the milling of the initial step is a grinding step.

50. The method of claim 44, wherein the carbon matrix has:
(i) a density of below about 1.5 g/cc;
(ii) a porosity of above about 65%; and/or
(i) a surface area (BET) of between about 10 m²/g to 500 m²/g.

51. The method of claim 44, wherein the carbon matrix is provided in the form of an amorphous carbon matrix, a crystalline carbon matrix, or a combination of both an amorphous carbon matrix and a crystalline carbon matrix.

52. The method of claim 44, wherein the amorphous carbon shell has:
(i) A density of greater than about 1.5 g/cc; and/or
(ii) A surface area (BET) of less than about 45 m²/g, for example less than 10 m²/g.

53. The method of claim 44, wherein the amorphous carbon shell further comprises additional materials from the group of titanium, aluminium, zirconium, niobium and selenium, or their oxides.

54. The method of claim 44, wherein a further thermal treatment step is applied to the composite material of step (iii), whereby the surface area thereof is reduced to less than 5 m²/g.

55. The method of claim 54, wherein prior to the further thermal treatment step the composite material of step (iii) has a hydrocarbon applied thereto.

56. The method of claim 55, wherein the hydrocarbon is provided in the form of 1,5-dihydroxynapthalene.

57. The method of claim 54, wherein an aqueous solvent is utilized in at least the thermal treatment of step (iii) and the further thermal treatment.

58. The method of claim 54, wherein the thermal treatment of step (iii) and the further thermal treatment each comprise:
(i) the dissolution of 1,5-dihydroxynapthalene in water; or
(ii) the dissolution of 1,5-dihydroxynapthalene in water at a temperature greater than about 70° C.

59. The method of claim 54, wherein the thermal treatment of step (iii), the additional thermal treatment and further thermal treatment are each provided in the form of pyrolysis.

60. The method of claim 44, wherein the thermal treatment of step (iii) is conducted at a temperature from about 700° C. to 1100° C.

61. The method of claim 45, wherein the additional thermal treatment by which the binder employed in the first agglomeration step is converted to carbon and forms in part the carbon matrix of the first composite is conducted at a temperature in the range of about 500° C. to 700° C.

62. The method of claim 54, wherein the further thermal treatment step is conducted at a temperature from about 800° C. to 1000° C.

63. The method of claim 44, wherein the first agglomeration step comprises spray-drying.

64. The method of claim 44, wherein the composite material is an anode composite.
